(19) United States
(12) Patent Application Publication
(10) Pub. No.: US 2007/0176472 A1
(43) Pub. Date: Aug. 2, 2007

(54) BICYCLE SADDLE

(76) Inventor: Louis Chuang, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/307,240

(22) Filed: Jan. 27, 2006

(51) Int. Cl. B62J 1/00

(52) U.S. Cl. 297/202

(57) ABSTRACT

A saddle includes a frame and an elastic element. The frame includes a front pad, two pads and a connective portion for connecting the front pad to the rear pads so that a space is defined between the front pad and the rear pads. The elastic element is installed on the connective portion in the space for supporting a rider's external genitals without excessively pressing the same.

### BACKGROUND OF INVENTION

1. Field of Invention

The present invention relates to a bicycle and, more particularly, to a bicycle saddle and, more particularly, to a bicycle saddle including a frame and an elastic element on the frame.

2. Related Prior Art

Bicycle riding is a very popular activity. Family members can enjoy bicycle riding together. Athletic persons can race on bicycles. In either case, people can obtain health from bicycle riding.

However, as experts worldwide assert, ridding on poorly designed saddles, male riders have their external genitals and perineum pressed and might suffer from erectile dysfunction and lose libido. Moreover, male riders might suffer saddle-related trauma that results in calcified masses in his scrotum.

Disclosed in Taiwanese Patent Application No. 941 40496 by the applicant of the present application is a saddle for that does not press male riders' external genitals and perineum. This conventional saddle seems, however, to provide inadequate support to male riders' external genitals and perineum.

The present invention is intended to obviate or at least alleviate the problems encountered in prior art.

### SUMMARY OF INVENTION

According to the present invention, a saddle includes a frame and an elastic element. The frame includes a front pad, two pads and a connective portion for connecting the front pad to the rear pads so that a space is defined between the front pad and the rear pads. The elastic element is installed on the connective portion in the space for supporting a rider's external genitals without excessively pressing the same.

The primary advantage of the saddle of the present invention is the appropriate support for male riders' external genitals and perineum.

Other advantages and features of the present invention will become apparent from the following description referring to the drawings.

### BRIEF DESCRIPTION OF DRAWINGS

The present invention will be described through detailed illustration of the preferred embodiment referring to the drawings.

FIG. 1 is a perspective view of a bicycle saddle according to the preferred embodiment of the present invention.

FIG. 2 is an exploded view of the saddle shown in FIG. 1.

FIG. 3 is a top view of the saddle shown in FIG. 1.

FIG. 4 is a side view of the saddle shown in FIG. 1.

FIG. 5 is a top view of a rider sitting on the saddle shown in FIG. 3.

FIG. 6 is a side view of the rider sitting on the saddle shown in FIG. 5.

### DETAILED DESCRIPTION OF PREFERRED EMBODIMENT

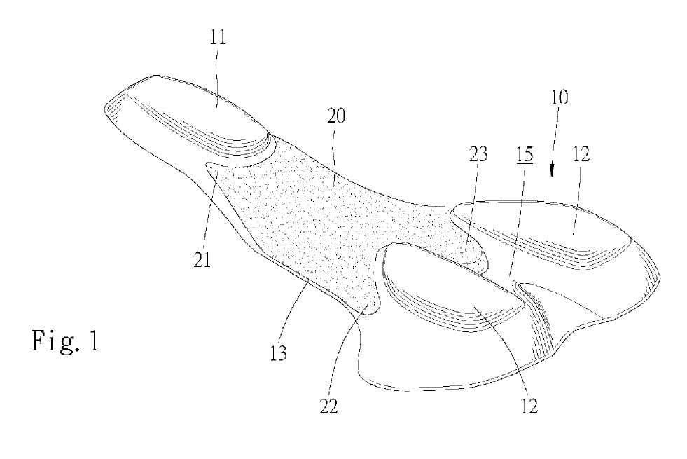

Referring to FIG. 1, there is shown a bicycle saddle according to the preferred embodiment. The saddle includes a frame 10 and an elastic element 20.

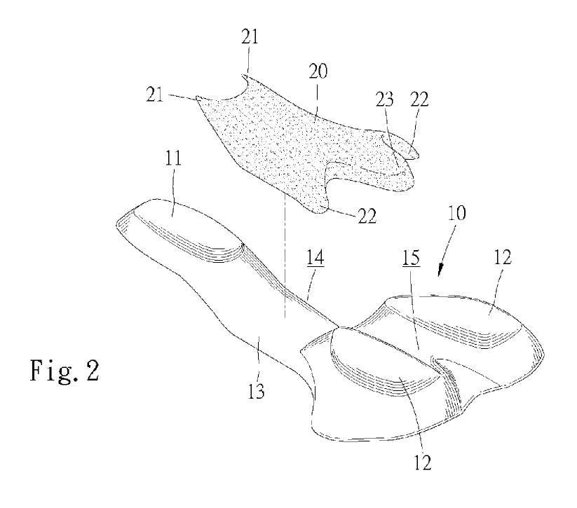

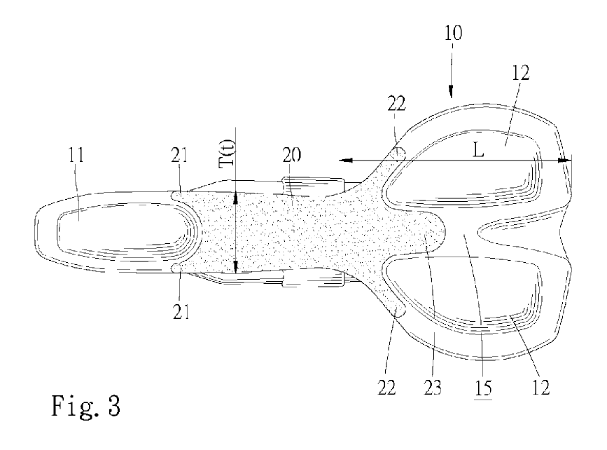

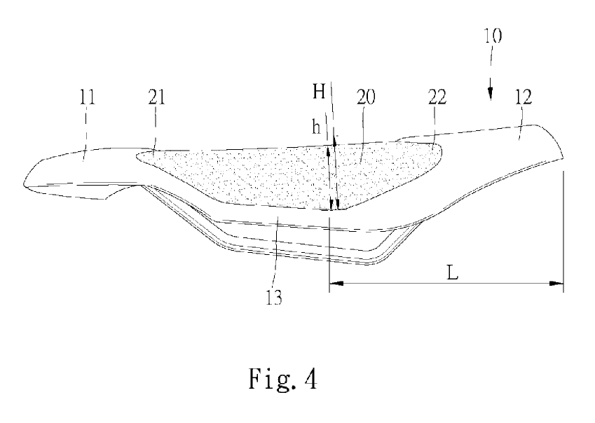

Referring to FIGS. 2 through 4, the frame 10 includes a front pad 11, two rear pads 12 and a connective portion 13 for connecting the front pad 11 to the rear pads 12. A space 14 is defined between the front pad 11 and the rear pads 1 2 above the connective portion 13. A space 15 is defined between the rear pads 12.

The length L of the rear pads 12 is no larger than 120 mm. In the preferred embodiment, the length L of the rear pads 12 is 120 mm. The width T of the connective portion 13 is no larger than 50 mm. In the preferred embodiment, the width T of the connective portion 13 is 40 mm. The depth of the space 14, i.e., the distance from a plane defined by the pads 11 and 12 to the top of the connective portion 13, is marked with “H.” The depth H of the space 14 is no larger than 30 mm. In the preferred embodiment, the depth H of the space 14 is 30 mm.

The elastic element 20 is installed on the connective portion 13 in the space 14. The elastic element 20 can support male riders' external genitals without excessively pressing the same. The elastic element 20 is softer than the front pad 11 and the rear pads 12 of the fame 10. The elastic element 20 can be attached to the frame 10 by means of adhesion, gluing, injection molding or in any other proper manner. The elastic element 20 includes a front concave edge 21 for wrapping the front pad 11 and two rear concave edges 22 for wrapping the rear pads 12. The elastic element 20 includes an extensive portion 23 between the rear concave edges 22. The extensive portion 23 of the elastic element 20 is located between the rear pads 12 within the space 15. Thus, the saddle is aesthetically pleasant and the connection of the elastic element 20 to the frame 10 is firm. The extensive portion 23 of the elastic element 20 can adequately support riders without excessively pressing them.

The width t of the elastic element 20 is identical to the width T of the connective portion 13. The thickness h of the elastic element 20 is marginally smaller than the depth H of the space 14.

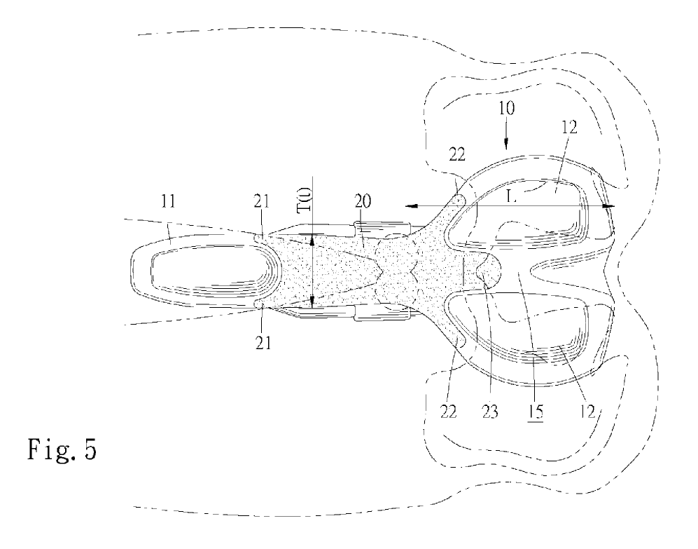

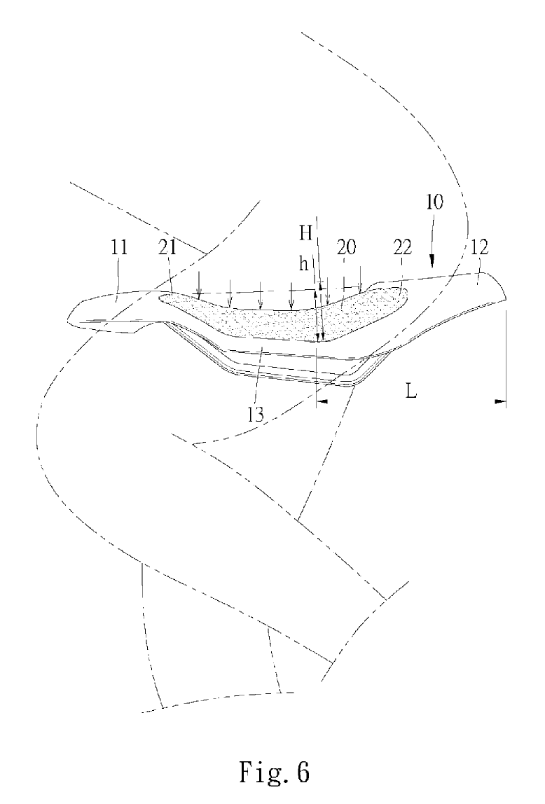

Referring to FIGS. 5 and 6, a rider rides on the saddle. The rider's hips are supported on the rear pads 12. The length L of the rear pads 12 is no larger than 120 mm for so that the rider's hips can be well supported and that the rider can feel comfortable.

While the rider is pedaling with legs, the rider's thighs are located beside the connective portion 13 and the elastic element 20. The width T of the connective portion 13 is identical to the width t of the elastic element 20 that is no larger than 50 mm so that the rider's thighs will not rub against the connective portion 13 and the elastic element 20. The slim profile of the saddle makes the saddle look advanced, modern and appealing to customers.

Moreover, the rider's external genitals are located on the elastic element 20 that is softer than the pads 11 and 12 of the frame 10. Hence, the external genitals can be supported without being excessively pressed so that the external genitals will not be hurt because of fierce vibration. The thickness h of the elastic element 20 is marginally smaller than the depth of the space 14. However, the elastic element 20 is thick enough to buffer the external genitals.

The saddle according to the present invention exhibits the following advantages.

Firstly, the elastic element 20 supports the rider's external genitals without excessively pressing the same.

Secondly, the space 14 is deep enough to buffer the rider's external genitals but not too deep to compromise the strength of the saddle.

Thirdly, the rear pads 12 are long enough to well support the rider's hips but not too long to hinder the rider's legs during pedaling.

Fourthly, the connective portion 13 and the elastic element 20 are not too wide to rub against the rider's thighs.

Fifthly, the advanced and streamline profile makes the saddle appealing to customers.

The present invention has been described through the illustration of the preferred embodiment. Those skilled in the art can derive variations from the preferred embodiment without departing from the scope of the present invention. Therefore, the preferred embodiment shall not limit the scope of the present invention defined in the claims.

1. A saddle comprising:
a frame comprising a front pad, a first rear pad, a second rear pad and a connective portion for connecting the front pad to the rear pads so that a space is defined between the front pad and the rear pads, wherein the rear pads each has a perimeter, wherein each of the perimeters has an outer side and an inner side, with the inner sides of the perimeters of the first and second rear pads facing each other; and
an elastic element installed on the connective portion in the space for supporting external genitals of a rider without excessively pressing the same, wherein the elastic element has a first portion and a second portion with the first portion extending beside the outer side of the perimeter of the first rear pad and the second portion extending beside the outer side of the perimeter on the second rear pad.

2. The saddle according to claim 1 wherein the length of the rear pads is no larger than 120 mm.

3. The saddle according to claim 1 wherein the width of the connective portion is no larger than 50 mm.

4. The saddle according to claim 1 wherein the width of the elastic element is identical to that of the connective portion.

5. The saddle according to claim 1 wherein the depth of the space is no larger than 30 mm.

6. The saddle according to claim 1 wherein the thickness of the elastic element is marginally smaller than the depth of the space.

7. A saddle comprising:
a frame comprising a front pad, two rear pads and a connective portion for connecting the front pad to the rear pads so that a space is defined between the front pad and the rear pads; and
an elastic element installed on the connective portion in the space for supporting external genitals of a rider without excessively pressing the same, wherein the elastic element comprises a front concave edge receiving the front pad.

8. A saddle comprising:
a frame comprising a front pad, two rear pads and a connective portion for connecting the front pad to the rear pads so that a space is defined between the front pad and the rear pads; and
an elastic element installed on the connective portion in the space for supporting external genitals of a rider without excessively pressing the same, wherein the elastic element comprises two rear concave edges receiving the rear pads.

9. The saddle according to claim 8 wherein the elastic element comprises an extensive portion formed between the rear concave edges so that the extensive portion of the elastic element is located in a space between the rear pads.

10. The saddle according to claim 1 wherein the elastic element is softer than the frame.

11. The saddle according to claim 1 wherein the frame comprises a space between the rear pads.

12. A saddle comprising:
a frame comprising a front pad, two rear pads and a connective portion for connecting the front pad to the rear pads wherein a first space is defined between the front pad and the rear pads and a second space is defined between the rear pads; and
an elastic element installed on the connective portion in the first and second spaces for supporting external genitals of a rider without excessively pressing the same, wherein the elastic element comprises two rear concave edges receiving the rear pads and an extensive portion between the rear concave edges so that the extensive portion of the elastic element is located in the second space between the rear pads.

13. A saddle comprising:
a frame comprising a front pad, two rear pads and a connective portion for connecting the front pad to the rear pads with a space defined between the front pad and the rear pads with a separation being defined between the rear pads,
wherein the rear pads have a first elevation and the separation has a second elevation with the second elevation lower than the first elevation; and
an elastic element installed on the connective portion in the space for supporting external genitals of a rider without excessively pressing the same,
wherein the elastic element extends to the separation between the rear pads and includes an extensive portion located in the separation between the rear pads.

14. The saddle according to claim 13 wherein the space between the front pad and the rear pads and the separation between the rear pads are contiguous.

15. The saddle according to claim 14 wherein the two rear pads further comprise a perimeter having a first area located on a first outer edge of the rear pad and a second area located on a second outer edge of the rear pad with the first and second areas contiguous with the space between the front pad and the rear pads and the separation between the rear pads.

16. The saddle according to claim 1 wherein the elastic element extends between the inner sides of the rear pads.
